(19) United States
(12) Patent Application Publication
(10) Pub. No.: US 2012/0317902 A1
(43) Pub. Date: Dec. 20, 2012

(54) MODULAR WALL SYSTEM

(76) Inventor: Paul Kapteyn, Onoway (CA)

(21) Appl. No.: 13/523,068

(22) Filed: Jun. 14, 2012

Related U.S. Application Data
(60) Provisional application No. 61/496,850, filed on Jun. 14, 2011.

(51) Int. Cl. E04B 2/56; E06B 1/04; E02D 27/32; E04B 1/64; E04C 2/20

(52) U.S. Cl. 52/204.1; 52/478; 52/408; 52/309.4; 52/293.1

(57) ABSTRACT

A modular wall system for a building structure that includes a plurality of pre-fabricated wall sections that are attachable to each other to form the foundation for the building structure. Each wall section forms the entire length of a wall of the foundation. The wall sections include a plurality of steel studs having a track attached thereto at the top and bottom, at least one structural insulated panel attached to the studs, and at least one waterproofing sheet attached to the outer surface of the structural insulated panels to allow the wall sections to be used below-grade.

### FIELD OF THE INVENTION

The present invention relates to a wall system for a building structure, and more particularly, a partially pre-fabricated wall system for use in a home or other building.

### BACKGROUND OF THE INVENTION

One of the most demanding applications for building materials is use in foundation or basement walls. Such walls structures are subject to the weight of the building, as well as the weight of the surrounding ground, which exerts forces normal to the wall or wall panels. Besides the structural demands, such walls and the materials constituting them must be reasonably water-resistant, and preferably have a reasonably high insulating value (R-value).

Standard residential and light commercial foundations are typically made of concrete-based products in a variety of different forms and embodiments. One embodiment is manufactured on the building site in the form of poured concrete. Another popular variation is pre-shaped and furnace-fired blocks (commonly called cinder blocks), which are manufactured at a factory and sent to a building site to be assembled using mortar and other well-known techniques. These types of structures have had wide acceptance, and have enjoyed apparent success in a number of variations and embodiments.

Yet another embodiment are self-contained concrete building foundation walls that are made entirely at a factory for shipment in large segments to building sites in which the concrete is poured into molds prior to shipment. It should be noted that large wall segments that are formed entirely at the factory are problematical due to the weight of the concrete. Using the alternative method of pouring the concrete at the building site introduces problems of quality control and uniformity.

There are a number of limitations to poured concrete or cinder block foundation walls. Despite its strength in compression, cinder block and even poured concrete walls fail due to constantly changing load factors brought on from drastic temperature changes (in conjunction with water migration into the wall material), water-saturated soil, soil shifting, and shock waves from earthquakes or the like.

Concrete and cinder block walls that are inundated by water are seldom able to resist the penetration of moisture. Moisture migration introduces the possibility of toxic mold occurring in residential buildings. Further, if the water remains standing around the wall, and freezes, structural failure certainly occurs as a result of loss of structural integrity of the concrete or cinder blocks. As a further complication, concrete has uneven drying characteristics. This can result in varying strengths throughout a poured concrete wall.

The molecular consistency of concrete is coarse. As a result, concrete has very little insulating value. Further, concrete absorbs, retains and wicks water to the interior of the structure that includes the foundation wall. This tendency is even more pronounced with cinder block. Just as moisture vapor can penetrate a concrete wall, so does Radon gas. This is particularly problematical in certain areas of Radon occurrence. This becomes particularly critical in basements used as exercise rooms since heavy breathing increases the likelihood of Radon intake.

Poured concrete for building foundation walls is expensive, complicated, and time-consuming. Less expensive alternatives, such as cinder blocks, are widespread. However, the use of cinder block has its limitations. For example, skilled masons are necessary to erect any structure using cinder block, and additional treatment of the wall (such as filling the holes in the blocks) are often necessary to provide minimum standards of insulation, structural strength, and resistance to moisture migration. Further, because mortar is used throughout a cinder block wall, the wall loses flexibility that might have been provided by the use of multiple pieces as opposed to solid slab of concrete.

Another drawback of concrete foundation walls is its very low insulation capability or R factor, usually in the range of 1.4 to 3.0. Consequently, additional insulation must be added to concrete foundation walls. This can be expensive, complex, and time-consuming.

Typical wall systems commonly known in the industry are panelized systems in which fully formed panels—often formed of materials other than concrete and cinder blocks—are delivered to a worksite in a piecemeal manner in which all of the pieces to form the wall are provided separately. Once at the worksite, the pieces are then put together to form the foundation walls. This assembly is usually done out in the open and subject to variations in weather and temperature and is typically labor-intensive and time-sensitive.

A need therefore exists for a wall system that can be partially pre-fabricated in a factory or location other than the building site that provides superior strength, durability, water resistance, insulation, and ease of construction and assembly with respect to concrete or cinder block walls. A need also exists for a wall system that minimizes the amount of worksite labor necessary to assemble the foundation for the building, thereby minimizing the effects of the weather and environment during installation.

### BRIEF SUMMARY OF THE INVENTION

In one aspect of the present invention, a modular wall system for a building is provided. The modular wall system includes a plurality of pre-fabricated wall sections, wherein each end of the wall sections is attached to another wall section at an angle thereto. Each of the wall sections includes a plurality of aligned studs, an upper track and a lower track attached to corresponding upper and lower ends of the studs. At least one structural insulated panel is attached to at least two of the studs. A waterproofing sheet is attached to an outwardly-directed surface of all of the structural insulated panels.

In another aspect of the present invention, a modular wall system for a building structure is provided. The modular wall system includes a plurality of pre-fabricated wall sections. Each wall section comprises a plurality of spaced-apart studs, the studs being aligned in a parallel manner. A plurality of structural insulated panels are attached to the studs, wherein each of the structural insulated panels extends between at least two of the studs. An upper track is attached to an upper end of at least two of the studs. A lower track is attached to a lower end of at least two of the studs. A waterproofing sheet is attached to an outwardly-directed surface of the structural insulated panels, wherein the waterproofing sheet extends from the outwardly-directed surface of the structural insulated panels and adjacent to a bottom of the lower track. Each end of each wall sections is attached to an end of an adjacent wall section.

In yet a further aspect of the present invention, a modular wall system for attachment to a foundation footer of a building is provided. The modular wall system includes a plurality of pre-fabricated wall sections. Each wall section includes a plurality of substantially parallel spaced-apart studs. A plurality of structural insulated panels are attached to the studs. The structural insulated panels are attached to each other by a tongue-and-groove attachment. A lower track is attached to a lower end of the studs. A waterproofing sheet is attached to an outwardly-directed surface of the structural insulated panels and extending below the lower track. Each end of each of the pre-fabricated wall sections is attached to another pre-fabricated wall section at an angle.

Advantages of the present invention will become more apparent to those skilled in the art from the following description of the embodiments of the invention which have been shown and described by way of illustration. As will be realized, the invention is capable of other and different embodiments, and its details are capable of modification in various respects.

### BRIEF DESCRIPTION OF SEVERAL VIEWS OF THE DRAWINGS

These and other features of the present invention, and their advantages, are illustrated specifically in embodiments of the invention now to be described, by way of example, with reference to the accompanying diagrammatic drawings, in which:

FIG. 1A is a perspective view of a portion of a modular wall system;

FIG. 1B is a top view of an embodiment of a modular wall system;

FIG. 1C is a top view of another embodiment of a modular wall system;

FIG. 2 is a side view of a pre-fabricated wall section;

FIG. 3 is an exploded view of the pre-fabricated wall section shown in FIG. 2;

FIG. 4A is a rear view of a wall section having a beam pocket for receiving a floor joist and a telescoping pole;

FIG. 4B is a top view of the wall section shown in FIG. 4A; and

FIG. 5 is a rear view of a wall section having an opening for a window.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF THE PREFERRED EMBODIMENT

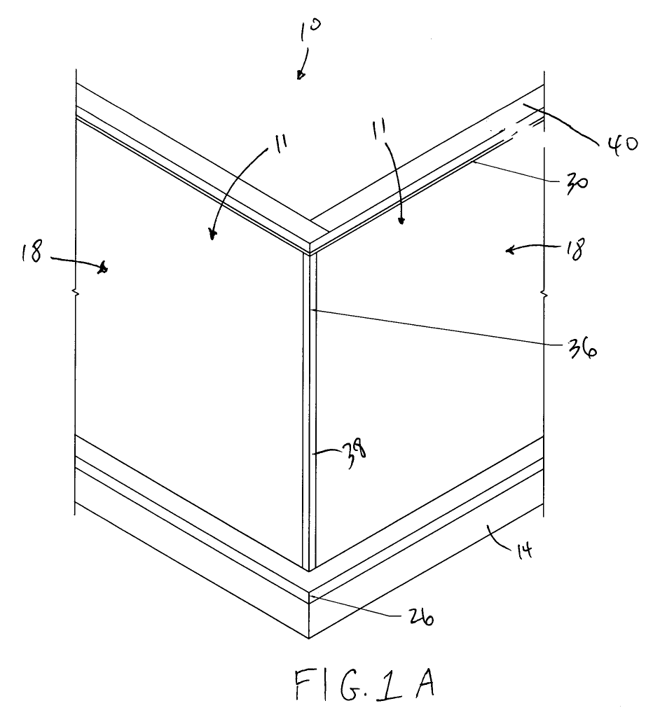

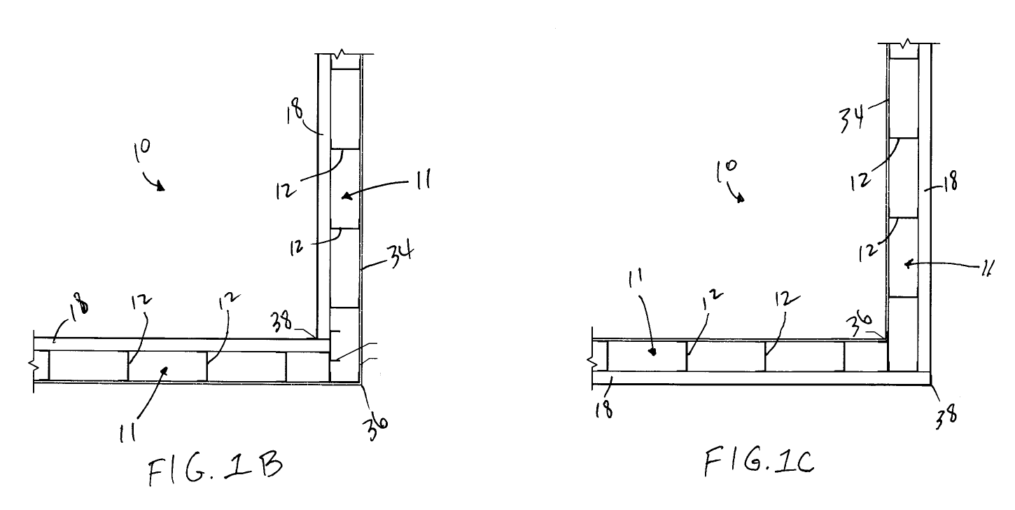

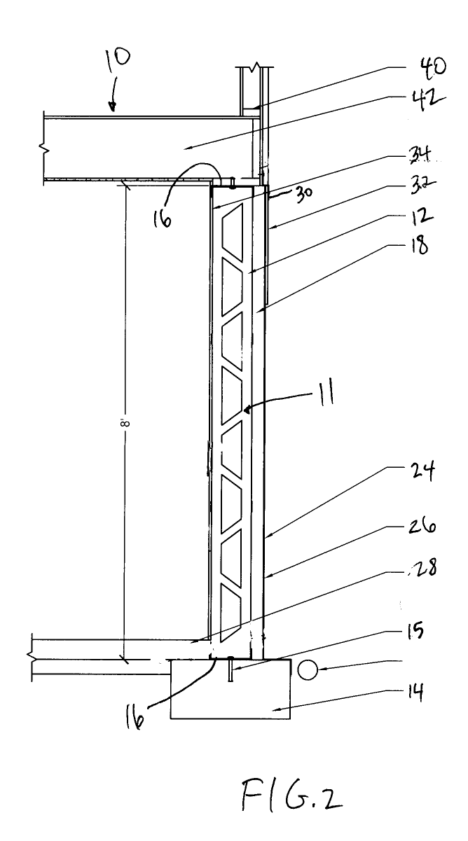

Referring to FIGS. 1A-1C, an exemplary embodiment of a wall system 10 is shown. Although the wall system 10 provided in the description below is in reference to the wall system being used in the basement of a house or dwelling, it should be understood by one of ordinary skill in the art that the wall system provided herein can be used as basement walls or any other structural walls of a building that are located below-grade.

The modular wall system 10 is formed of a plurality of wall sections 11, wherein each wall section 11 is pre-fabricated in a location away from the worksite and subsequently shipped to the worksite at which the plurality of wall sections 11 are joined together in an end-to-end manner at an angle to each other to enclose an interior space therewithin. Referring to FIGS. 1A-1C, an exemplary embodiment of a wall section of the modular wall system 10 is shown in the installed position along a concrete footer 14 that was previously installed at the worksite, and each wall section 11 is attached to the footer 14 by at least one anchor bolt 15. Although the exemplary embodiment of the modular wall system 10 shown in FIGS. 1A-1C illustrates only two wall sections 11 joined to form one corner of the building, it should be understood by one of ordinary skill in the art that the remaining modular wall system 10 which provides the entire foundation is formed by joining the other wall sections 11.

In an embodiment, each wall section 11 includes a plurality of vertically oriented studs 12, as shown in FIGS. 1A-1C and 2-3. The studs 12 are oriented in a substantially parallel manner relative to each other. Although the illustrated embodiment of the wall section 11 includes only two studs 12, it should be understood by one of ordinary skill in the art that the wall section 11 includes a sufficient number of spaced-apart studs 12 to extend along the entire length of the wall to be installed. It should also be understood by one of ordinary skill in the art that because each wall section 11 forms an entire length of a wall of the foundation, each wall section 11 may have a different overall length and thus, a different number of studs 12. In an embodiment, the studs 12 are spaced about sixteen inches (16″) apart from each other. It should further be understood by one of ordinary skill in the art that because the building codes in different countries, states, counties, and/or cities may differ, the spacing of the studs 12 may be closer or further apart to comply with these building codes. In an embodiment, a track 16 extends between and is attached to two adjacent studs 12 at both the top and bottom of the studs 12. In another embodiment, a track 16 extends between and is attached to two ore more studs 12 at both the top and bottom of the studs 12. The tracks 16 can either extends the entire length of the wall section 11 or multiple sections of tracks 16 can be attached together or spaced apart to extend along the entire length of the wall section 11 on the upper and lower edges thereof. In an embodiment, the studs 12 and tracks 16 are formed of structural steel, and more particularly, sixteen gauge steel. It should be understood by one of ordinary skill in the art that the studs 12 and tracks 16 can also be formed of fourteen gauge steel or any other material sufficient to withstand the loads expected to be experienced by the wall system 10. FIG. 1B illustrates a corner in which two wall sections 11 are joined at an angle in which the outwardly-directed surfaces of the wall system 10 form the acute angle, and FIG. 1C illustrates a similar corner in which two wall sections 11 are joined at an angle in which the outwardly-directed surface of the wall system 10 form the obtuse angle.

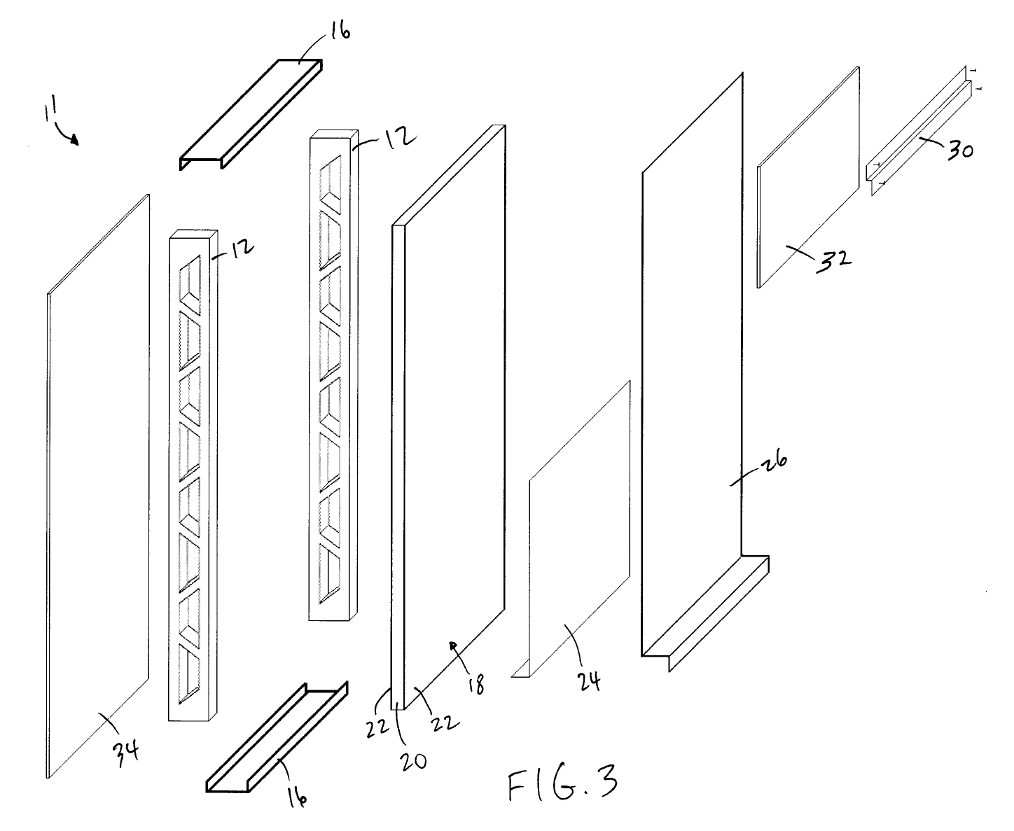

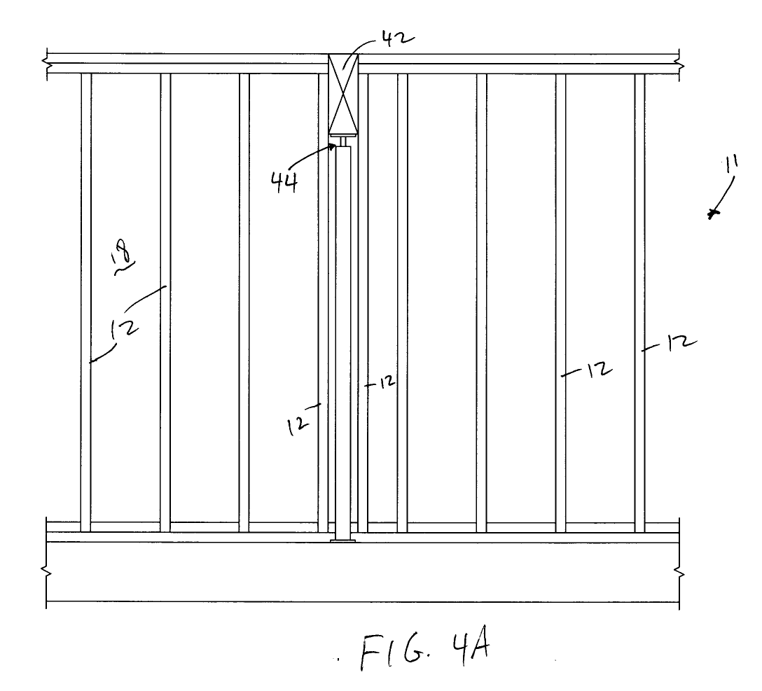

As shown in FIGS. 2-3, a structural insulated panel (“SIP”) 18 extends between at least a pair of adjacent studs 12 and is attached to the outwardly-directed edge of the studs 12. Each structural insulated panel 18 is formed of a core material 20 that is sandwiched between a pair of structural sheets 22. The structural sheets 22 can be formed of steel, aluminum, ceramic, composite materials, fiberglass, or other material sufficient to withstand the various loads experienced by the structural insulated panel 18. In an embodiment, the structural sheets 22 are formed of twenty-four gauge steel positioned adjacent to each side of the core material 20. The core material 20 is configured to provide waterproofing protection when positioned below-grade as well as provide insulation to reduce heat loss through the structural insulated panel 18. In an embodiment, the core material 20 is formed of closed cell polyurethane or polyisosianate foam. The core material 20 is integrally bonded with the opposing structural sheets 22 during manufacture of the structural insulated panel 18. For example, the core material 20 can be a spray foam that is sprayed between the opposing structural sheets 22 such that during curing and drying of the core material 20, the core material 20 adheres to both of the structural sheets 22 to form a substantially rigid panel.

The height of each structural insulated panel 18 is determined by the particular job for which they are being used. For example, in a basement having a ceiling height of eight feet (8′), the height of the structural insulated panel 18 is about eight feet; and in a building having a foundation or basement having a ceiling height of ten feet (10′), the height of each of the structural insulated panels 18 is about ten feet. In an embodiment, the structural insulated panels 18 have a width between about thirty-six inches (36″) and forty-two inches (42″). To form a wall section 11 having more than one structural insulated panels 18, adjacent panels are aligned vertically and are connected by way of a tongue-and-groove connection along adjacent vertical edges. Each structural insulated panel 18 is attached to the studs 12 by way of a screw driven through a stud 12 and into the inwardly-directed structural sheets 22 that is positioned immediately adjacent to the stud 12. The structural insulated panel 18 is attached to the stud 12 with a screw attachment spaced apart about every foot along the vertical height of the stud 12. The structural insulated panel 18 is configured to resist the earth load as well as the diagonal forces on the wall, thereby keeping the wall system 10 from wracking.

In an embodiment, a single continuous piece of a waterproofing sheet 24 is positioned immediately adjacent to at least a portion of the outwardly-directed surfaces of all of the structural insulated panels 18 of an entire wall section 11, as shown in FIGS. 2-3. In an embodiment, the waterproofing sheet 24 can be formed of high density polyethylene (HDPE) plastic, low density polyethylene (LDPE) plastic, or any other sheet material sufficient to provide a thin waterproof barrier to at least a portion of outwardly-directed surface of the structural insulated panels 18 of a wall section 11. This waterproofing sheet 24 is seamless over the length and height of the wall and used for waterproofing and keeping the skin of the structural insulated panels 18 from contacting the ground. The waterproofing sheet 24 extends along at least a portion of the outer skin as well as below the lower track 16 such that a portion of the waterproofing sheet 24 is positioned between the lower track 16 and the footer 14 when the wall section 11 is installed. The waterproofing sheet 24 extends vertically up the structural insulated panels 18 to the maximum depth of the desired backfill of dirt that will be adjacent to the particular wall section 11. For example, if the plans for the building require the entire foundation to be below-grade, the waterproofing sheet 24 extends the entire height of the structural insulated panels 18; however, if the backfill of dirt only extends two feet (2′) above the footer 14, then the waterproofing sheet 24 extends vertically from the lower track 16 at least two feet (2′) to ensure that the top of the waterproofing sheet 24 is above the backfill. In an embodiment, the waterproofing sheet 24 is a peel-and-stick membrane that allows for ease of attachment of the waterproofing sheet 24 to the outer structural sheet 22 of each structural insulated panel 18 as well as provides a waterproof barrier to prevent water from seeping between the structural insulated panel 18 and the lower track 16.

As shown in FIGS. 2-3, a sealing sheet 26 is positioned adjacent to the outwardly directed structural sheet 22 of the structural insulated panel 18 and the waterproofing sheet 24 such that the waterproofing sheet 24 is positioned between the sealing sheet 26 and the structural insulated panel 18. In an embodiment, the sealing sheet 26 extends along the height and width of the wall section 11 in a continuous seamless piece. The sealing sheet 26 also extends over the outside of the upper and lower tracks 16 and extends below the lower track 16 such that a portion of the sealing sheet 26 covers the footer 14 and extends below the upper surface of the footer 14. As such, when the wall section 11 is attached to the footer 14, the sealing sheet 26 provides an initial waterproofing barrier that extends the entire height and width of the wall section as well as covers a portion and extends around the outer edge of the footer 14 so that any water that runs down the outside of the sealing sheet 26 is directed below the footer 14 and is prevented from entering any potential gap between the lower track 16 of the wall section 11 and the footer 14. The sealing sheet 26 can be formed of high density polyethylene (HDPE), low density polyethylene (LDPE), or any other material sufficient to provide a substantially waterproof outer layer. The sealing sheet 26 provides additional waterproofing protection to the wall section 11 as well as abrasion protection while transporting the wall section 11 and backfilling dirt against the wall section 11.

At the top of the wall section 11, the sealing sheet 26 and the structural insulated panels 18 are secured to the wall section 11 by a metal flashing 30 that extends the entire length of the wall section 11, as shown in FIGS. 2-3. A custom finish 32 can also be added adjacent to the top edge of the wall section 11 and positioned between the sealing sheet 26 and the flashing 30. The finish 32 may be formed of steel or any other material and configured to be an above-grade addition as determined by the customer. Further after-installation details can also be added to the wall sections of the wall system 10, including drywall After securing the wall section 11 to the footer 14, the wall section 11 is further locked into place by pouring the concrete floor 28 into the wall cavity between adjacent studs 12 and against the inwardly-directed structural sheet 22 of the structural insulated panel 18, as shown in FIG. 2. By pouring the concrete floor 28 into the cavity at the bottom of the wall section 11, the problem of an internal water leak that would otherwise fill the wall cavity to the depth of the floor is eliminated.

In an embodiment, the structural insulated panels 18 of an embodiment have a thickness of about two and a half inches (2.50″) and have an insulation rating of R15, exceeding most standards. In another embodiment, the structural insulated panels 18 can also have a thickness of up to about six inches (6.0″) and have an insulation rating of R45. It should be understood by one of ordinary skill in the art that the structural insulated panels 18 can be formed of any thickness and have any R-value to provide sufficient structural stability to the wall system 10 as well as provide sufficient insulation to the interior space. The integrated insulation capacity of the structural wall sections 11 eliminates any insulation from having to be installed within the space between the studs 12, thereby leaving the dew point within the insulation where it is not exposed to air (no condensation). In another embodiment, a spray foamed can be used between the opposing structural sheets 22 to form the structural insulated panels 18, as spray foam sticks to steel quite well. The finished wall section 11 can remain unfinished, as the inwardly-directed structural sheet 22 of the structural insulated panels 18 is non-combustible, meeting a typical 15 minute fire rating building code.

The modular wall system 10 includes a plurality of wall sections 11, wherein each wall section 11 forms an entire length of a wall, and the plurality of wall sections 11 are attached to each other at corners, as shown in FIGS. 1A-1C. The wall sections 11 are pre-fabricated off-site such that each wall section 11 is delivered to the building site as a fully-assembled piece. Once the wall sections 11 are delivered to a worksite, each wall section 11 is positioned adjacent to the footer 14 and attached thereto by way of a plurality of anchor bolts 15, as shown in FIG. 3. At the intersection of two wall sections 11 that form a corner 36, a piece of finish flashing 38 (FIG. 1A) extends over the immediately adjacent vertical edges of both wall sections 11 to secure and attach the wall sections 11 together. In an embodiment, a piece of finish flashing 38 is attached to both the inner surface and the outer surface of the corner 36. The modular wall system 10 reduces the amount of installation time because the wall sections 11 arrive at the worksite fully assembled such that the only installation required on-site is attaching the wall sections 11 to the footer 14 and securing adjacent wall sections 11 to each other at the corners 36. The modular wall system 10 provides a plurality of redundant layers of waterproofing protection. Additionally, the use of the sealing sheet 26 around the edge of the footer 14 eliminates water from coming under the wall section 11 from the outside. In an alternative embodiment, the wall sections 11 can be finished without a sealing sheet 26 at all, thereby allowing individual builders to waterproof the walls with traditional methods a desired height rather than waterproofing the entire wall system 10.

The exterior structural insulated panels 18 provide diagonal bracing between the studs 12 as well as retain the earth load of the backfill.

In an embodiment of a structural insulated panel 18, polyurethane foam is injecting as a liquid between the two structural sheets 22, making a permanently bonded, integrated panel. The structural insulated panels 18 are tightly fastened to the studs 12 from the inside of the wall, creating a significantly stronger, stiffer wall section 11. By not having fasteners extending through the panel, fasteners rusting out due to condensation at the dew point is eliminated, as well as potential leaks. The sealing sheet 26 located adjacent to the footing 14 sheds water to below the top of the footing 14. The concrete floor 28 is poured at the same level into the wall section 11, right up to the inside surface of the structural insulated panels 18. This eliminates a water trough, and permanently locks the wall section 11 together at the bottom connection to the footing 14.

The modular wall system 10 is non-combustible.

The construction process of each of the wall sections 11 includes: aligning and spacing the studs 12 apart relative to each other at the desired length of the wall; positioning a track 16 adjacent to the top and bottom edges of the aligned studs 12; attaching a track 16 to the top edge of the studs 12 using a fastener, such as a ¾″ pam fast self drilling torx drive screw, for example, through the track 16 and stud 12 flanges; aligning a plurality of structural insulated panels 18 adjacent to the outwardly-directed flanges of the studs 12; attaching the plurality of structural insulated panels 18 together such that adjacent panels are attached to each other using a tongue-and-groove connection; attaching the structural insulated panels 18 to the studs 12 using fasteners such as a pam fastener ¾″ self drilling screws, for example, wherein the screws are used about every 14″ over the height of the studs 12; attaching a waterproofing sheet 24 to the outwardly-directed structural sheet 22 of the structural insulated panels 18, wherein the waterproofing sheet 24 extends around the bottom of the lower track 16; attaching a continuous, seamless sealing sheet 26 along the entire height and width of the wall section 11 such that the sealing sheet 26 extends beyond the lower track 16, which allows for the sealing sheet 26 to cover the top and edge of the footer 14; attaching a piece of flashing 30 at the top edge of the wall section 11 to secure the sealing sheet 26 to the track 16 and structural insulated panels 18; finishing the wall section 11 with customer-determined additions such as an above-grade finish flashing 38 or drywall 34.

Installation of the wall sections 11 to form the modular wall system 10 includes: lifting the wall sections 11 by crane and positioning each of them on top of the footer 14; adjusting the sealing sheet 14 such that it extends below the top edge of the footer 14; joining each of the wall sections 11 at the corners 36; attaching the wall sections 11 to the footer 14 using anchor bolts 15 such as ⅜″×3″ red head anchor bolts, for example, wherein the anchor bolts 15 extend through the center of the lower track 16; attaching a wooden sill plate 40 (FIG. 1A); pouring the concrete floor 28 such that the concrete covers a portion of the bottom of the wall sections 11 between the studs 12; and sealing the outside corners 36 with a piece of finish flashing 38.

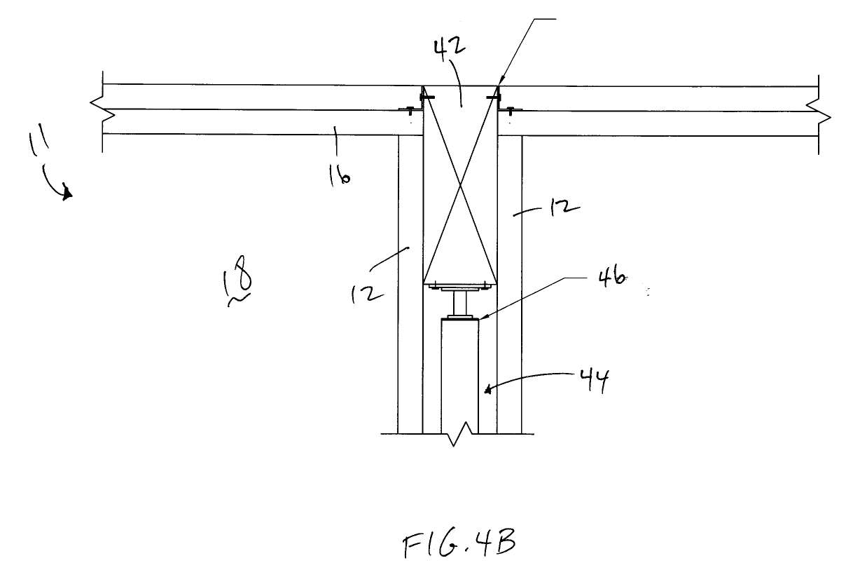

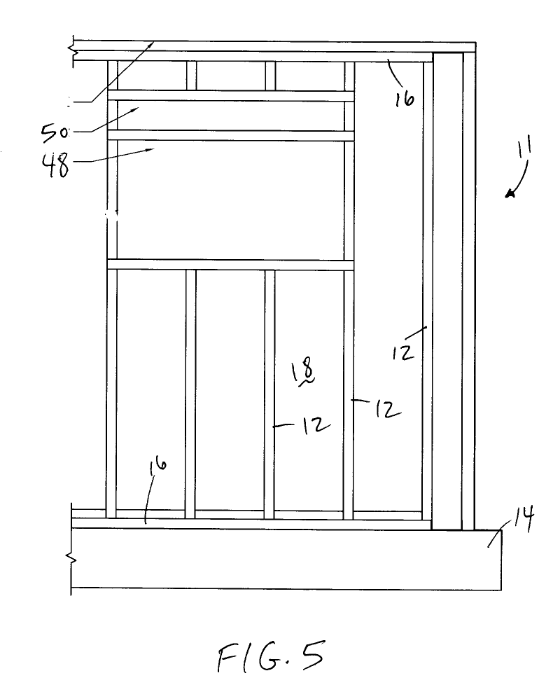

When the modular wall system 10 is used for a building that has a horizontal floor joist 42, a beam pocket 44 is formed between adjacent studs 12 of a wall section 11, as shown in FIGS. 4A-4B. It should be understood by one of ordinary skill in the art that although the portion of the wall section 11 shown in FIGS. 4A-4B include only a single beam pocket 44, any number of beam pockets 44 can be formed along the length of a wall section 11 to allow for a sufficient number of floor joists 42 to be used. To form the beam pocket 44 within a wall section, a pair of adjacent studs 12 are spaced apart a distance just larger than the width of the floor joist 42 to allow the floor joist 42 to be positioned between the studs 12. In an embodiment, the lower track 16 extends between the pair of studs 12 and is configured to receive a telescoping post 46 that supports the floor joist 42. In another embodiment, the lower track 16 does not extend between the pair of studs 12 forming the beam pocket 44. In an embodiment, the upper track 16 does not extend between the pair of studs 12. In the embodiment illustrated in FIG. 3, the upper track 16 extends between the pair of studs 12 forming the beam picket 44, and the floor joist 42 is positioned above the upper track 16. The telescoping post 46 allows for easier and more accurate alignment of the floor joist 42, and allowing the telescoping post 46 to be received in the beam pocket 44 of the wall section 11 reduces the additional installation time that would otherwise be required to position the floor joist 42 and align it with shims.

Wall sections 11 of the modular wall system 10 can also include integrated openings 48 configured to receive a window or door. FIG. 5 shows an opening 48 for a window formed into the wall section 11. The opening 48 is created by placing breaks in the studs 12 and an aperture through the structural insulated panel 18. To ensure reinforcement about the window or door, a steel header 50 is positioned above the opening 48 and integrated into the wall section 11.

While preferred embodiments of the present invention have been described, it should be understood that the present invention is not so limited and modifications may be made without departing from the present invention. The scope of the present invention is defined by the appended claims, and all devices, process, and methods that come within the meaning of the claims, either literally or by equivalence, are intended to be embraced therein.

What is claimed is:

1. A modular wall system for a building comprising a plurality of pre-fabricated wall sections, wherein each end of said wall sections is attached to another wall section at an angle thereto, each of said wall sections includes a plurality of aligned studs, an upper track and a lower track attached to corresponding upper and lower ends of said studs, at least one structural insulated panel attached to at least two of said studs, and a waterproofing sheet attached to an outwardly directed surface of all of said structural insulated panels.

2. The modular wall system of claim 1, wherein said structural insulated panels are formed of a core material sandwiched between a pair of steel sheets.

3. The modular wall system of claim 1 further comprising a sealing sheet attached to an outwardly directed surface of said structural insulated panels, wherein at least a portion of said waterproofing sheet is located between said sealing sheet and said outwardly-directed surface of said structural insulated panels.

4. The modular wall system of claim 3, wherein said sealing sheet is a continuous, seamless member extending an entire length of said wall section to which it is attached.

5. The modular wall system of claim 3, wherein said sealing sheet extends beyond said lower track and covers a portion of a footer to which said wall section is attachable.

6. A modular wall system for a building structure comprising:
a plurality of pre-fabricated wall sections, wherein each wall section comprises:
a plurality of spaced-apart studs, said studs being aligned in a parallel manner;
a plurality of structural insulated panels attached to said studs, wherein each of said structural insulated panels extends between at least two of said studs;
an upper track attached to an upper end of at least two of said studs;
a lower track attached to a lower end of at least two of said studs; and
a waterproofing sheet attached to an outwardly-directed surface of said structural insulated panels, wherein said waterproofing sheet extends from said outwardly-directed surface of said structural insulated panels and adjacent to a bottom of said lower track; and
wherein each end of said wall section is attached to an end of an adjacent wall section.

7. The modular wall system of claim 6, wherein said upper and lower tracks are each a single member.

8. The modular wall system of claim 6, wherein at least one of said upper and lower tracks is formed of multiple sections of track.

9. The modular wall system of claim 6, wherein each of said structural insulated panels is formed of a core material having a pair of steel sheets attached to opposing sides thereof.

10. The modular wall system of claim 9, wherein the core material is polyisosianate foam.

11. The modular wall system of claim 6, wherein each of said wall sections further include a sealing sheet positioned adjacent to said outwardly directed surface of said structural insulated panels, wherein at least a portion of said waterproofing sheet is located between said sealing sheet and said outwardly-directed surface of said structural insulated panels.

12. A modular wall system for attachment to a foundation footer of a building, said modular wall system comprising:
a plurality of pre-fabricated wall sections, each wall section comprising:
a plurality of substantially parallel spaced-apart studs;
a plurality of structural insulated panels attached to said studs;
a lower track attached to a lower end of said studs; and
a waterproofing sheet attached to an outwardly-directed surface of said structural insulated panels and extending below said lower track;
wherein each end of each of said pre-fabricated wall sections is attached to another pre-fabricated wall section at an angle.

13. The modular wall system of claim 12, wherein each of said wall sections further comprises an upper track attached to an upper end of said studs.

14. The modular wall system of claim 12, wherein each of said structural insulated panels if formed of a pair of opposing sheets of steel attached to a core material.

15. The modular wall system of claim 14, wherein said core material is polyisosianate foam.

16. The modular wall system of claim 12, wherein at least one of said pre-fabricated wall sections includes an opening for receiving a door or a window.

17. The modular wall system of claim 12, wherein each of at least two of said pre-fabricated wall sections includes at least one beam pocket for receiving a telescoping post and a floor joist.
